(19) United States
(12) Patent Application Publication
(10) Pub. No.: US 2017/0115852 A1
(43) Pub. Date: Apr. 27, 2017

(54) NESTED FOLDER CONTROL

(71) Applicant: Wrap Media, LLC, San Francisco, CA (US)

(72) Inventors: Jared L. FICKLIN, Austin, TX (US); Matthew J. SANTONE, Austin, TX (US); Ian MCFARLAND, San Francisco, CA (US)

(21) Appl. No.: 15/334,400

(22) Filed: Oct. 26, 2016

Related U.S. Application Data
(60) Provisional application No. 62/246,813, filed on Oct. 27, 2015.

(51) Int. Cl. G06F 3/0481; G06F 3/0488; G06F 17/22; G06F 3/0482; G06F 3/0484

(52) U.S. Cl. CPC G06F 3/04817; G06F 3/0482; G06F 3/04842; G06F 17/2247; G06F 3/04883; G06F 2203/04803

(57) ABSTRACT

A screen of a computing device displays a parent folder and child folders and digital objects contained within the parent; no other folders or objects are displayed. A user taps a child folder once and the child folder opens; displayed on the screen are any of its child folders and any digital objects contained within the original child folder. Once opened, the parent folder is no longer displayed and neither are any of its child folders or digital objects. A single tap upon an open folder moves up a level in the hierarchy; the child folders and digital objects of the open folder are removed from the display, and the parent folder of the open folder is displayed. Also displayed are any child folders of the parent folder and any digital objects contained within the parent folder. A single tap upon a functional icon creates a new child folder.

### CROSS REFERENCE TO RELATED APPLICATIONS

This application claims the benefit of U.S. Provisional Patent Application No. 62/246,813, filed on Oct. 27, 2015, which is incorporated by reference in its entirety.

### BACKGROUND

This invention relates to a computer user interface, and more particularly, to an interface for allowing a user to manage storage on a computing device.

Although the file folder metaphor has been a popular metaphor for the storage of computer files on desktop computers, this type of user interface does not lend itself well to other types of computing devices. For one, use of this file folder user interface typically relies upon the underlying operating system of the computer in order to display the file folders and to allow a user to manage them. But, mobile telephones in particular, and other computing devices, do not allow a user to access the underlying operating system or to use its file management constructs. Thus, a user of these devices cannot use the underlying operating system in order to create and manage their own storage.

Moreover, as each computing device (laptop, desktop, tablet computer, etc.) will typically have its own operating system and its own particular user interface metaphor to allow a user to create and manage their own storage, there is no common metaphor that can work across many different devices. Thus, this traditional model breaks down in the context of cloud-based computing and cloud-based distribution of applications and data. For software applications that are distributed from the cloud across many of a variety of types of computing devices, there is no common storage metaphor that will work across all of these devices and that will be familiar to a user whether he or she is using their mobile telephone, a tablet computer or their desktop computer.

Various software programs exist that address user-managed storage, and each provide its own metaphor for how a user creates folders, names them, nests folders, etc. For example, the program “File Explorer” in the Microsoft operating system and the program “Finder” in the Apple operating system are examples of operating system-specific programs that provide a visual metaphor by which the user may create their own folders and store data within a particular operating system. Some programs are cloud based; the applications “Dropbox,” “Evernote” and “Google Drive” are examples of cloud-based software programs that each provide its own visual metaphor by which a user creates folders and stores data. As mentioned above, each of these interfaces provide their own visual representation and technique for managing folders and data, and will not necessarily work across all types of computing devices, especially on touchscreen mobile telephones.

Within the Android operating system on mobile telephones there are third-party applications that may be downloaded that allow a user to browse local files within the operating system, as well as on Apple devices. But, these applications each require their own specific user interaction to manage data and do not lend themselves to implementation on other devices such as click-enabled computing devices that use a mouse instead of a touchscreen.

In particular, there is a need for a user interface storage metaphor that is common across many computing devices whether they are touchscreen devices or click-enabled devices that use a computer mouse or similar. And, there is also a need for a technique that minimizes the number of touches, swipes, clicks or selections that a user must perform in order to manage storage folders.

An improved user interface metaphor and storage technique would not rely upon the user interface metaphor of the local operating system of the computing device and would function across many different types of computing devices. Such a storage technique would also minimize the number of clicks or touches required to manage data.

### SUMMARY

The present invention is directed to a technique for allowing a user of a computing device to create and manage their own storage using a metaphor that is common across many different types of computing devices and requires minimal touches or clicks. The technique may be implemented within a native application upon a computer or mobile telephone or within a Web browser. In one specific implementation, the technique is used by an end user on a computing device to store and manage a wrap package of cards (as is described below), or may be used by a developer of a wrap package to store and manage wrap packages, to store and access assets for the wrap package, to organize templates, etc. This implementation allows wrap packages to be stored and managed easily on a mobile telephone or similar touchscreen device. Further, the items stored and managed may also be documents, images, videos, music files, sound files, executable files, etc.

The present invention presents a novel parent-child-sibling hierarchy that reduces the number of touches or clicks required to traverse through the hierarchy. Only one click, touch or similar input is needed to initiate an action within the hierarchy such as opening a child folder, going back up a level, opening a file, creating a new folder, etc. Unlike more complex interfaces, no additional input is needed such as a right-click or center-click button, a back button, etc. And, the input required to traverse the hierarchy is the same whether the user is using a touchscreen device or a click-enabled device.

In a first embodiment a screen of a computing device displays a parent folder and any child folders and digital objects contained within the parent folder; no other folders or objects are displayed. When a user taps a child folder once the child folder is opened and the child folder is displayed on the screen along with any of its child folders and any digital objects contained within the original child folder. Once opened, the parent folder is no longer displayed and neither are any of its child folders or digital objects.

In a second embodiment a screen of a computing device displays an open folder and any of its child folders and digital objects contained within that open folder. A single tap by the user upon the open folder moves up a level in the hierarchy; the child folders and digital objects of the open folder are removed from the display, and the parent folder of the open folder is displayed. Also displayed are any child folders of the parent folder (including the open folder) and any digital objects contained within the parent folder.

In a third embodiment a screen of a computing device displays an open folder and a child folder along with a functional icon allows a user to create a new child folder. With a single tap by the user upon the functional icon a new child folder is created and is displayed along with the original child folder. The new child folder may be named automatically by default or the user may input a new name. The functional icon remains allowing the user to create yet another new folder.

### BRIEF DESCRIPTION OF THE DRAWINGS

The invention and the advantages thereof, may best be understood by reference to the following description taken in conjunction with the accompanying drawings in which:

FIG. 1 is a diagram illustrating a wrap package layout that includes a plurality of cards threaded together so as to be viewable in linear arrays in accordance with the principles of the present invention.

FIG. 2 is a diagram depicting the design, functionality and data integration capabilities of a representative card in a digital companion wrap package according to the principles of the present invention.

FIG. 3 is a diagram illustrating the media content and distribution model for distributing digital companion wrap packages in accordance with the principles of the present invention.

FIG. 4 is a block diagram of a representative system for authoring, storing, distributing and consuming wrap packages in accordance with the principles of the present invention.

FIG. 5 is a screen shot of a computing device on which a creator is creating a wrap package and makes use of the present invention.

FIG. 6 is a screen shot of a computing device that appears after the user has tapped upon the folder icon.

FIG. 7A shows a parent folder that includes three child or sibling folders.

FIG. 7B shows how the screen transforms after the user taps once upon the “Spring” child folder.

FIG. 7C shows how the screen transforms after the user taps once upon the “Folder A3” child folder.

FIG. 7D shows how the screen transforms after the user taps once upon the “New” icon.

FIG. 8 illustrates yet another example of how the present invention may appear on the screen of a computing device.

FIG. 9 is a flow diagram describing one embodiment in which a child folder is opened and displayed.

FIG. 10 is a flow diagram describing one embodiment in which a user moves up one level in a hierarchy.

FIG. 11 is a flow diagram describing one embodiment in which a user opens a new folder.

In the drawings, like reference numerals are sometimes used to designate like structural elements. It should also be appreciated that the depictions in the figures are diagrammatic and not to scale.

### DETAILED DESCRIPTION OF THE PREFERRED EMBODIMENTS

The invention will now be described in detail with reference to various embodiments thereof as illustrated in the accompanying drawings. In the following description, specific details are set forth in order to provide a thorough understanding of the invention. It will be apparent, however, to one skilled in the art, that the invention may be practiced without using some of the implementation details set forth herein. It should also be understood that well known operations have not been described in detail in order to not unnecessarily obscure the invention.

The above-listed related applications describe a new media content type, referred to as “wrap packages”. The terms “wrap” or “package” are interchangeably used herein to refer to wrap packages.

A wrap package is a collection of cards that are each selectively authored to include (i) one or more types of media content such as text, images, photos, video, etc., (ii) application functionality and/or (iii) e-commerce related services. The cards in a wrap are also typically authored to define one or more linear sequence(s) when consumed. With wrap packages, an author thus has the ability to select media content, combined with application-like and website functionality, and combine them all into an elegant, card-based, narrative. As a result, the author can create compelling stories using media, interwoven with interactive functionality and/or e-commerce services. Wrap packages are, therefore, ideal, but not necessarily limited to, delivering a unique, interactive, “book-like”, experience to the mobile web, which previously has been not possible.

The cards of wrap packages are navigation metaphors. Each card can be authored to group related information that can be easily consumed within a user interface experience by swipe (or other simple gesture) navigation from card-to-card.

Cards have a visual representation intended to evoke similarities to their physical counterparts. They have a fixed portrait aspect ratio that makes them ideally suited to current mobile computing devices as well as easy to scale up to and arrange to fit other display form factors, such as provided on laptop and desktop computers as well as smart TVs. The physical card metaphor can also extend to the interactive behavior of cards in a wrap, as the user can use gestures that evoke the “flipping” of cards in a deck or bound booklet to navigate between them.

In addition, each card in a wrap has defined content that is displayed in a predefined layout. In general, the cards in a wrap have the same size and aspect ratio. The aspect ratio is preferably device independent and is preferably maintained regardless of device orientation and/or display window size.

Cards are like containers for holding and distributing media content, such as text, images, photos, audio, video and the like. In addition, cards may also contain or hold executable objects that provide or enable real-time features, such as application functionality (i.e., the ability to schedule appointments, engage in online chats or conversations) and support e-commerce related services (i.e., the ability to purchase goods and/or services). The multimedia content and/or interactive services contained by any given card can be determined entirely in advance or as late as the moment the wrap is consumed by the end-user. Such media content and executable objects are sometimes referred to herein as card “assets.”

Cards, however can differ from their physical counter-parts in ways that provide for unique presentations of content or the aforementioned application functionality and/or e-commerce services. For example, a gallery card provides the ability to present an expanded amount of content in a vertically stacked orientation such that the overall length (i.e., the number of cards in a horizontal sequence) of the wrap is not affected by the amount of content in the wrap. This aids in navigation since the user can flip to the previous or next card regardless of their current position in the gallery.

Wrap packages are delivered and rendered in a browser as a sharable and savable message. Wrap packages thus provides an app-like user experience that is delivered as a live, interactive, message from a cloud-based platform, using for example, the Software as a Service (SaaS) model. A wrap is thus a portable container of multimedia content, and interactive services, designed for ease of delivery, exchange, and consumption.

Wrap packages are also consumable anywhere, meaning they have the ability to be resolved and displayed on just about any type of device (mobile phones, laptops, tablets, wearable computing devices such as smart watches, desktop computers, smart TVs, etc.), regardless of the platform (e.g., iOS, Android, Microsoft, etc.). Wrap packages are thus platform and device independent. Wraps do not have to be written for any specific platform, such as iOS or Android, or for any specific device or class of devices (e.g. smart phones, tablets, desktops, etc.).

Wrap packages are thus a mobile-first marketing and commerce platform that ideally provides a beautiful world of storytelling in bite-size moments that get and hold attention. In addition, the unique characteristics of (i) authoring once and running on almost any device, regardless of the operating system or the type and the ability to easily distribute wrap packages similar to messages, together are a powerful construct that potentially can make the use of wrap packages near universal.

By creating wrap packages, businesses and other organizations can simply and cheaply create, distribute, and manage storytelling mobile web user experiences, app like functionality and e-commerce, all in the context of wrap packages delivered directly to consumers. Where businesses used to have to build destinations (websites) or use monolithic systems (apps), they can now provide consumers, particularly mobile device users, with a user experience that delivers the content they want combined with a complementary palette of functions and/or e-commerce related services.

Wrap packages thus solves a number of current problem with the mobile web. Unlike web sites, wrap packages are easy to consume on mobile devices and offer the opportunity to create compelling narratives and user experiences. In addition, the ability to incorporate app-like functionality into wraps provides a multi-function app-like experience, without having to develop an app, be in an app, download an app, or open several apps.

The uniqueness of wrap packages creates opportunities for business and other organizations alike to innovate and improve marketing efforts, customer support, and user experiences in ways previously not possible, because an enabling interface and platform did not exist. Wrap packages can thus potentially define the next generation interactive web paradigm, particularly for mobile, although for desktop and other types of devices as well.

The cards of the wrap packages are ideally authored in one or more linear sequences so that a book-like narrative unfolds, not only through the cards themselves, but also by the transition between the cards, as they are sequentially browsed. In addition, the wrap packages are portable objects that may exist within a social feed or within a custom application. Wrap packages are also readily distributed, similar to electronic messages, through e-mail, messaging, social-media, or via a variety of other electronic communication platforms. As a result, wrap packages are consumable, sharable and savable objects. As the cards are browsed in the one or more linear sequences during consumption, the user experiences the unfolding of the authored narrative, including the defined media content interwoven with the complementary application functionality and/or e-commerce related services. As a result, the entire user experience including any application functionality and/or e-commerce related services is substantially contained within the context of the wrap package itself, typically (but not necessarily) without the need to navigate to other sites.

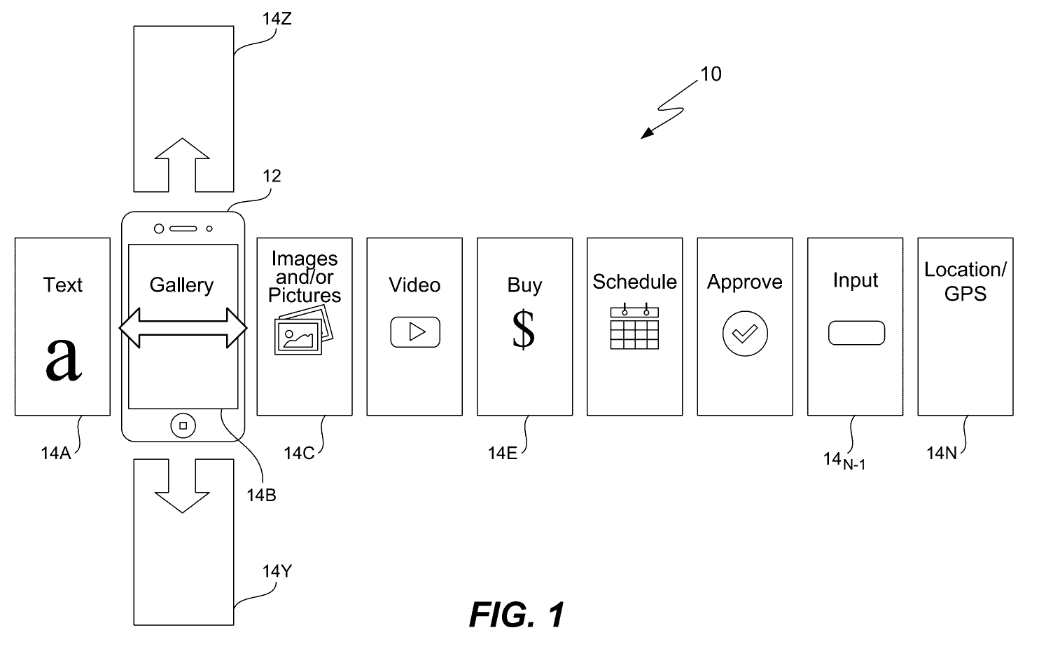

Referring to FIG. 1, a diagram of a non-exclusive embodiment of a wrap package 10 viewable on a computing device 12 is illustrated. The wrap package 10 includes a plurality of cards 14 that are threaded together so as to enable browsing by swiping in one or more linear sequences. Any of the cards 14 may optionally include various types of media, such as text, images or photos, audio, video, a live or streaming feed of media, 3-D objects, or content from other wrap packages (not illustrated). Any of the cards 14 may also optionally provide application functionality, such as the ability to receive input data or display dynamically generated data, a calendar for scheduling or booking appointments or making reservations for goods and/or services, location/GPS, etc. In addition, any of the cards 14 may optionally provide or support e-commerce services, such as the ability to browse products in a catalog, communicate with an online sales representative, and/or purchase product(s).

By way of example, in the schematically illustrated wrap package 10, card 14_{A} includes text, card 14_{B} presents a gallery, card 14_{C} includes images or pictures, card 14_{D} includes a video, card 14_{E} includes e-commerce related service(s), card 14_{F} includes a calendar function for scheduling appointments and/or booking reservations, card 14_{G} includes a user approval function, 14ₙ₋₁ includes a data entry function, card 14_{N} includes location or GPS services, etc.

On computing devices with touch sensitive screens, the cards 14 of wrap packages 10 can be navigated linearly by swiping or by using other suitable interfaces, such as a stylus or pen. In devices without a touch sensitive screen, alternative user interfaces are provided to facilitate transition (e.g., flipping) from one card to the next. In the context of the present application, the terms “swipe-browsing” or “swiping” is intended to mean the navigation from one card to an adjacent next card. With devices with touch sensitive screens, swipe browsing is typically implemented by the sliding of a finger or other input device across the display. With devices without touch-sensitive screens, other navigation tools such as a mouse, keyboard or remote control, can be used for swipe browsing. When a swipe is performed, the content of the next card in the sequence is displayed. For example, by swiping either right to left or vice versa, the next card, depending on the swipe direction, in the horizontal sequence is displayed. Similarly, by swiping up and/or down, the next card in either the up or down sequence is displayed. Thus, the user experience when consuming a wrap package is the wrap package itself (as opposed to a remote web site for example), viewable via a swipe-able interface.

Additionally, some cards may also include one or more embedded link(s) that, when selected, enable navigation to either a non-adjacent card not in linear sequence or to another wrap package, a web page or some other location entirely outside of the wrap package.

It should be noted that the particular layout of cards 14 in the wrap package 10 illustrated in FIG. 1 is merely illustrative. Both the number of rows and/or columns, and the number of sequential cards 14 within any given row or column, may vary widely as appropriate to deliver the desired user experience, narrative, content, functionality and services of the wrap package 10.

With gallery cards, such as card 14_{B} of FIG. 1, swiping allows for the scrolling through of the contents of a card 14, which are typically too voluminous to be displayed within the size of a fixed screen display, such as that provided on a mobile phone. In an illustrative example, a particular wrap package 10 may include a plurality of cards organized in a horizontal sequence. By swiping right to left or vice versa, the next card 14 or the previous card 14 in the horizontal sequence is displayed. In the vertical direction, however, one or more selected cards 14_{B} may be configured in the gallery format, allowing the viewer to scroll up or down by swiping through media content of the gallery. In an illustrative but non-exclusive example, a wrap package 10 authored and distributed by a car rental business may include a horizontal sequence of cards 10, each dedicated to a category of information pertinent to a traveler (i.e., cards dedicated to local hotels, restaurants, local tourist attractions respectively). By swiping up or down for a given card, relevant material within each category is displayed in a gallery format. For instance by swiping up or down the hotel card (not illustrated), a gallery of a number of local hotels is displayed. In variations of the gallery card format, the behavior invoked by an up or down swipe may differ. For example, swiping up or down my result in a continuous “rolling” of the content of the gallery card. In other embodiments, an up or down swipe may result in a “snap” action with the next item of content appearing after the snap, for example, as illustrated as cards 14Y and 14Z in FIG. 1.

The wrap package 10 is identified, as described in more detail below, through the use of a unique identifier (wrap ID 42) assigned to the package 10. By way of example, the wrap ID 42 may take the form of a Uniform Resource Identifier (URL). As such, the wrap ID may thus be provided as a link, which can readily be used to effectively send or retrieve the wrap package. That is, the wrap package may effectively be “sent” to a potential viewer as a link using any of the wide variety of mechanism that can currently—or in the future—be used to send a link or convey the URL. By way of example, this may include e-mail messages, text messages, SMS messages, via a Twitter tweet, as a post on social media such as Facebook, etc., discussion forums, walls or the like, as a link embedded in a document, an image, or a web page or any other media type, in a blog or microblog (e.g. Tumblr), or any other messaging or electronic content distribution mechanism or communication platform currently known or developed in the future.

Wrap packages are therefore significantly different and more powerful than web sites. For example with wrap packages, they can be consumed “on the spot” where it is located (i.e., when delivered to a mobile device for example). In contrast with the selection of a banner ad appearing within a web site, where the viewer is taken to a new web page that is not (a) necessarily designed for mobile devices and (b) is self navigating, making it very difficult for a narrative to be conveyed. As a result, the user experience, particularly on mobile devices, may be very poor. Hence, the friction of providing a compelling user experience with wrap packages is far less than with web site.

The cards 14 of a wrap 10 can be displayed on the screen of virtually any type of computing device. It should be appreciated that the card metaphor is particularly well suited for use on mobile devices such as smart phones, tablet computers, etc., which makes the format particularly powerful for authors interested in developing content tailored for mobile devices. By delivering wrap packages 10 to mobile devices, users and potential customers can be won over at their point of intimacy, where they spend their time and consciousness. Wrap packages thus allow authors, merchants and other content providers to create compelling narratives and provide ongoing application functionality and/or e-commerce support directly delivered anytime and anywhere to users, transforming their mobile devices into a powerful business tool that enhances mobile engagement and relationships. As a result, higher customer satisfaction, better brand engagement, and a higher conversion (i.e., click-through rates) and repeat e-commerce related activity compared to other forms of after sale promotions and merchandising will likely result.

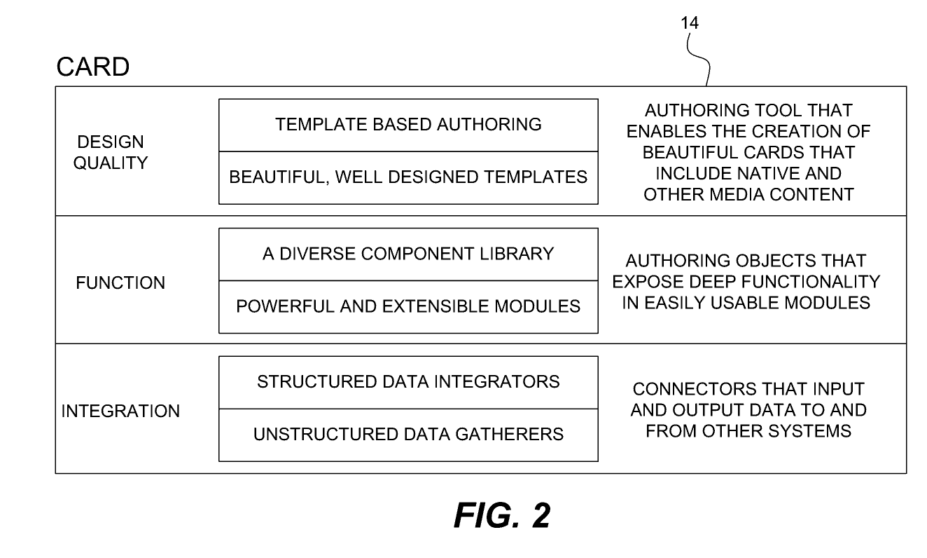

Referring to FIG. 2, a diagram depicting the design, functionality and data integration capabilities of a representative card 14 in a wrap package 10 is shown.

By using card templates, authoring tools and media collaboration tools, beautiful, content-rich, cards 14 may be created either by automation or by individuals with even minimal design skills and experience. As such, the author, either a person or an automated process, has the ability to easily create beautiful content-rich cards 14 that can selectively include text, images, photos, and other media similar to PDF files, but optionally, with the added benefit of additional application functionality and/or e-commerce related services, either embedded in the same card 14, or other cards 14, in the wrap package 10. In the automated authoring embodiments, the content of a card 14 can be populated by a data processing system that automatically uploads predefined content into various defined fields of a card template.

By authoring (i) the horizontal and/or vertical sequence order for swipe-browsing the cards 14, (ii) the media content in each card 14, (iii) application functionality and/or (iv) the e-commerce services for each card 14, it is possible to author Wrap packages 10 that are content-rich, highly interactive, and that define a palette of services, functions and experiences related to the wrap package 10, all within the context of a story book-like narrative that unfolds as the cards 14 are browsed in their sequence order(s).

In addition, the use of component libraries and the authoring tools allow for the authoring of cards 14 with a diverse, easy to use, reusable, set of component modules that provide a wide variety of application functions and e-commerce services. Such application functions include, but are not limited to, for example, calendar functions, scheduling of an appointment functions, reserving or booking goods and/or services, such as a car rental, hotel room, or table at a restaurant, map or GPS related functions, support for online conversations, streaming live video or other media feeds, etc. In addition, e-commerce related services include displaying product and/or service offerings, displaying user account information, engaging a sales representative in an online chat session, and enabling the purchase of goods and/or services, etc. These card services or “plugins” are all part of an ecosystem supported by a Wrap run-time engine viewer (described in more detail below), which allows the various plug-in services to all communicate and inter-operate together. For example, a calendar plugin could be configured to communicate with a reservation booking database plugin, which could communicate with a chat plugin. The communication among the various plug-in services is accomplished through a common set of APIs. As a result, the interactivity, functionality and usefulness of wrap packages 10 are significantly enhanced by such an ecosystem of connected plug-in services.

Finally, the integration capabilities of cards 14 enable the bi-directional flow of data from users browsing a wrap package 10 to other cards 14 in the same wrap package 10, to another wrap package 10, or a remote data processing system. For example, a card 14 can be integrated with the back end software system for a large online retailer, which will automatically populate the content of a card 14 with product images, user account information, prior purchase information, and a host of other user-related information. Alternatively, a card 14 can be used to capture data input from a user and provide it to a retailer's back end e-commerce software system. For example, a card 14 may display a one-click “Buy Now” function for a displayed item. When the Buy Now function is selected, previously saved user account information is automatically delivered to the back end software system of the online merchant, which then processes the information to complete the transaction.

The data entered by the user and/or the data presented via a card 14 of a wrap package 10 may thus be integrated with the back-end database, cloud computing services, web sites, etc., regardless if managed by an author and/or distributor of the wrap package or by a third party. The data processing for the purchase of goods and/or services, appointments, and/or other application functionality and e-commerce related services may, therefore, be performed either within the wrap packages 10 itself or integrated with a remote data processing resource.

The data integration capabilities of cards 14 can also be shared among other cards 14 in the same wrap package 10, with other wrap packages, with web sites, or just about any other data processing system.

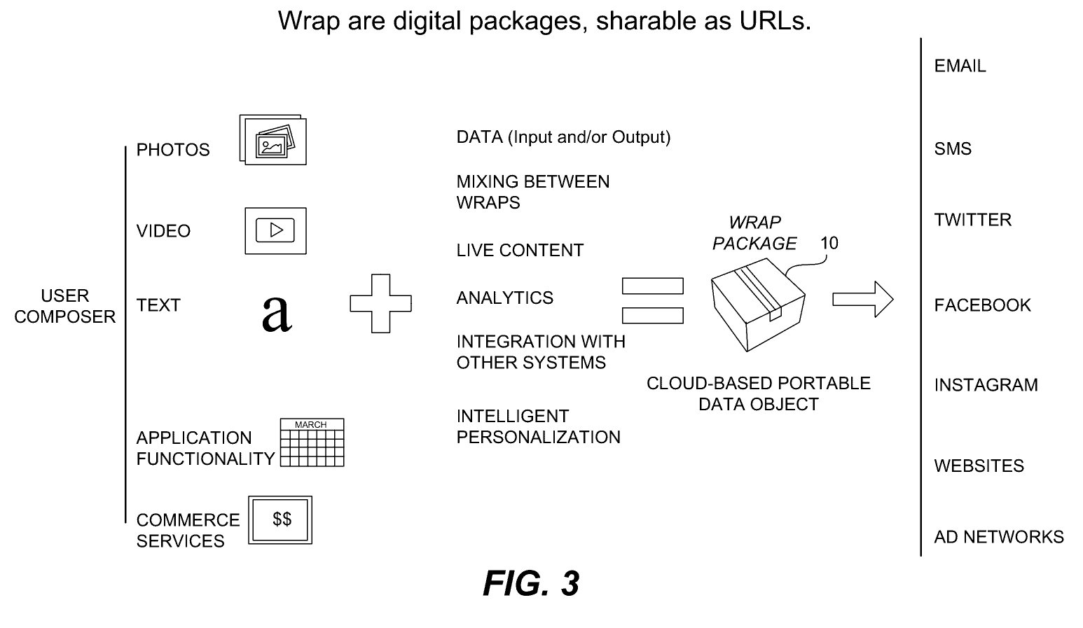

Referring to FIG. 3, a diagram summarizing the content and distribution model for wrap packages 10 is shown. As illustrated in the left most column, the content that may be included in the various cards 14 of a wrap package 10 may include photos and/or images, audio, video, text, 3-D objects, various types of streaming media (e.g., audio, video, audiovisual, data, biometric information, tickers, sensor outputs, etc.), other data types, application functionality and/or e-commerce services. This content may further be combined with content mixed from other wrap packages 10 as well as live or streaming content. The cards 14 of the wrap package 10 may be further modified based on analytics, intelligent personalization based on the demographics of targeted users or viewers, as well as the integration of either data input or data output to/from with other cards 14, other wrap packages 10, or remote data processing systems and processes, as explained above.

All of the above are then combined during the authoring process into a group of digital objects, defined herein as the wrap package 10. In non-exclusive embodiments where URLs are used as identifiers (i.e., wrap ID 42), the wrap packages are “light-weight”, meaning content of the wrap package 10 is delivered over a network to a user only when the wrap ID 42 for the wrap package 10 and/or each card 14 is identified. As a result, the media content, application functionality, and/or e-commerce related services is delivered only when needed. Also, by authoring the cards 14 using a widely supported language such as HTML, the cards 14 of wrap packages 10 can be written once and are viewable on a display associated with almost any computing device running a browser. Accordingly, unlike applications, multiple version of a wrap package 10 need not be authored for multiple platforms.

The wrap package 10 is thus essentially a cloud based portable object that may be readily distributed in a number of ways. In non-exclusive examples, wrap packages 10 may be distributed by email, SMS messaging, ad networks, Twitter, merchant/retailer web sites, photo and/or video sharing web sites that support messaging, social networking web site such as Facebook, through the down-loading of applications from aggregators such as the Apple App Store or Google Play, or just about any means for electronically distributing data over a network, currently known or developed in the future.

### Authoring and Distribution of Wrap Packages

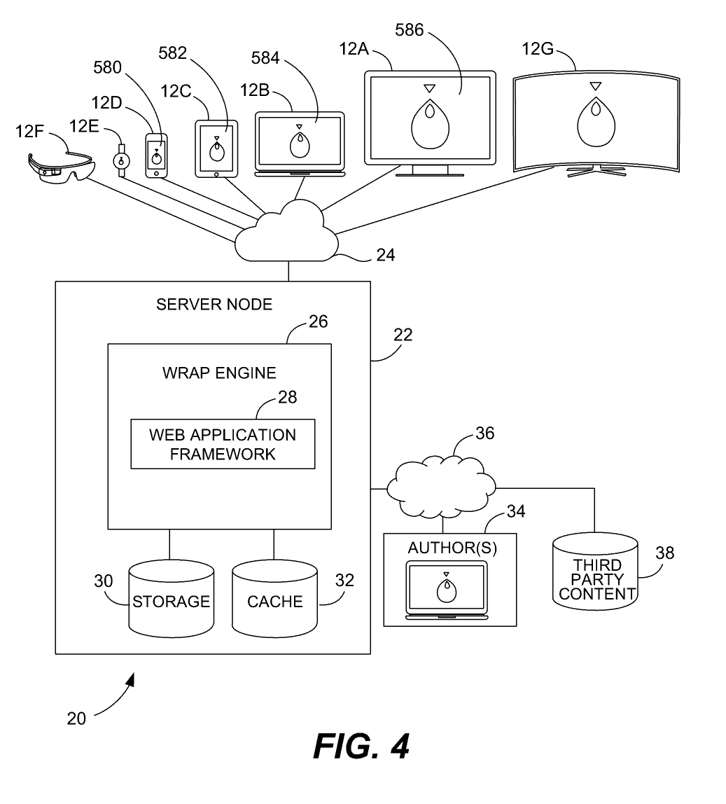

Referring to FIG. 4, a block diagram of a non-exclusive system for authoring, storing, distributing and consuming wrap packages 10 is illustrated. The system 20 includes a server node 22, a plurality of computing devices 12, including but not limited to a desktop computer 12A, a laptop computer 12B, a tablet computer 12C, a mobile “smart” phone 12D, a wearable computing device, such as a smart watch 12E or smart glasses 12F and “smart” TVs 12G. The server node 22 and the computing devices 12A-12G communicate with one another over a network 24. In various embodiments, the network 24 may be the Internet, an intranet, a wired or wireless network, a Wi-Fi network, a cellular network, other types of communication networks, or any combination thereof.

The server node 22 includes a “wrap” engine 26, which defines a web application framework 28, a storage device 30 and cache 32, each for storing wrap packages 10 and other data. The server node 22 also may include a suite of tools, such as an authoring tool (as described in detail below), an analytic engine tool, a media collaboration tool and a data transformation tool, for authoring wrap packages 10.

The web application framework 28 is a software platform designed to support the manual and/or automated authoring of wrap packages 10. The framework 28 is designed to alleviate the overhead associated with common activities performed during the authoring of many wrap packages 10. For example, the framework 28 may include one or more libraries to help with the authoring of common tasks, and modularizes and promotes the reuse of code designed to perform specific tasks, such as implementing application functionality and/or supporting e-commerce. In various embodiments, the web application framework 28 may be implemented using, but is not limited to, Ruby, Rails, JavaScript, Angular-JS, and/or any other language or framework currently known or developed and used in the future.

In a non-exclusive embodiment, the web application framework 28 of the wrap engine 26 also performs content management as a way of organizing, categorizing, and structuring the media and other content resources such as text, images, documents, audio files, video files and modularized software code so that the content of wrap packages 10 can be stored, published, reused and edited with ease and flexibility. The content management function is also used to collect, manage, and publish content, storing it either as components or whole documents, while maintaining dynamic links between the components and/or cards 14 of a wrap package 10.

In yet another non-exclusive embodiment, the web application framework 28 of the wrap engine 26 is structured around multiple tiers, including but not limited to a client tier, an application tier and a database tier. The client tier refers to the browser enabled communication devices 12 that execute and display cards 14 of wrap packages 10, as well as web pages written in HTML or another mark-up language. The database tier, which is maintained in storage 30, contains the one or more libraries of user and/or platform provided media content, software components, modules, etc. used for the authoring of wrap packages 10. The application contains the software that runs on the server node 22 and that retrieves and serves the appropriate wrap package 10 from storage 30 and/or cache 32 when requested by a computing device 12.

Since wrap packages 10 are essentially data objects, they can be both cached and delivered over a Content Delivery Network Interconnection (CDN), both of which can be effectively used to deliver wrap packages 10 with minimal delay. For example, commonly requested wrap packages 10 may be cached in the cache 32, which provides faster access and delivery times than storage 30. Also other caching techniques, such as pre-caching, may be used with popular wrap packages 10, to speed up delivery times. Since the amount of storage in the cache is typically limited, cached wrap packages 10 and other data may be periodically replaced by any known replacement algorithm, such as first-in, first-out or least recently used for example.

During the composing of a wrap package 10, one or more author(s) 34 may access the server node 22 over a network 36, which may be different or the same as network 24. The author(s) 36 interact with the wrap engine 26, including the web application framework 28, and the above-mentioned suite of tools for the creation, editing, optimization and storing of wrap packages 10. In yet other embodiments, the one or more author(s) 34 can also access third party content 38 for inclusion into a wrap package 10. As previously noted, wrap packages 10 can be authored manually by one or more individuals or electronically in an automated process.

For more details on cards 14 of wrap packages, see U.S. provisional application Nos. 62/062,056 and 62/062,061, both entitled “Wrapped Packages of Cards for Conveying a Narrative With Media Content, Providing Application Functionality, and Engaging Users in E-commerce”, both filed Oct. 9, 2014, and both incorporated by reference herein for all purposes.

For more details on authoring cards of wrap packages, see U.S. provisional application Nos. 62/144,139 and 62/170,438, filed Apr. 7, 2015 and Jun. 3, 2015 respectively, both entitled “Authoring Tool for the Authoring of Wrap Packages of Cards,” both of which are incorporated by reference herein for all purposes. Also see U.S. patent application Ser. Nos. 14/740,539, 14/740,533, 14/740,617 and 14/740,839, all filed Jun. 16, 2015, all entitled “Authoring Tool for the Authoring of Wrap Packages of Cards,” and all of which are incorporated by reference herein for all purposes.

Once the authoring of a wrap package 10 is complete, it is maintained in storage 30 and possibly cached in cache 32. In response to receiving an identifier, the wrap engine 26 fetches the corresponding wrap package 10 from storage 30 or the cache 32 and serves it to the requesting computing device 12 for consumption in a format customized for the viewing device.

It should be noted that the authoring and distribution diagram of FIG. 4 is merely representative and should not be construed as limiting. For example, multiple server nodes 22 for the authoring and/or distribution of wrap packages 10 may be provided at the same or different locations. In addition, multiple instantiations of a given wrap package can 10 be stored at multiple server nodes 22, typically located at different geographic locations. With this arrangement, the server node 22 that is most capable of quickly delivering a requested wrap package 10, sometimes referred to as the “publication server”, is the node 22 that will deliver the wrap package to the requesting device 12.

### Nested Folder Examples

As mentioned above, the present invention provides a user interface storage metaphor that provides the same user experience across a wide variety of computing devices, such as devices 12A-120 shown in FIG. 4. And, the invention may be utilized by any end-user of a mobile telephone, laptop computer, etc., who is storing, organizing or deleting wrap packages (including other digital items such as documents or images), as well as any developer, creator or author of a wrap package or other digital item.

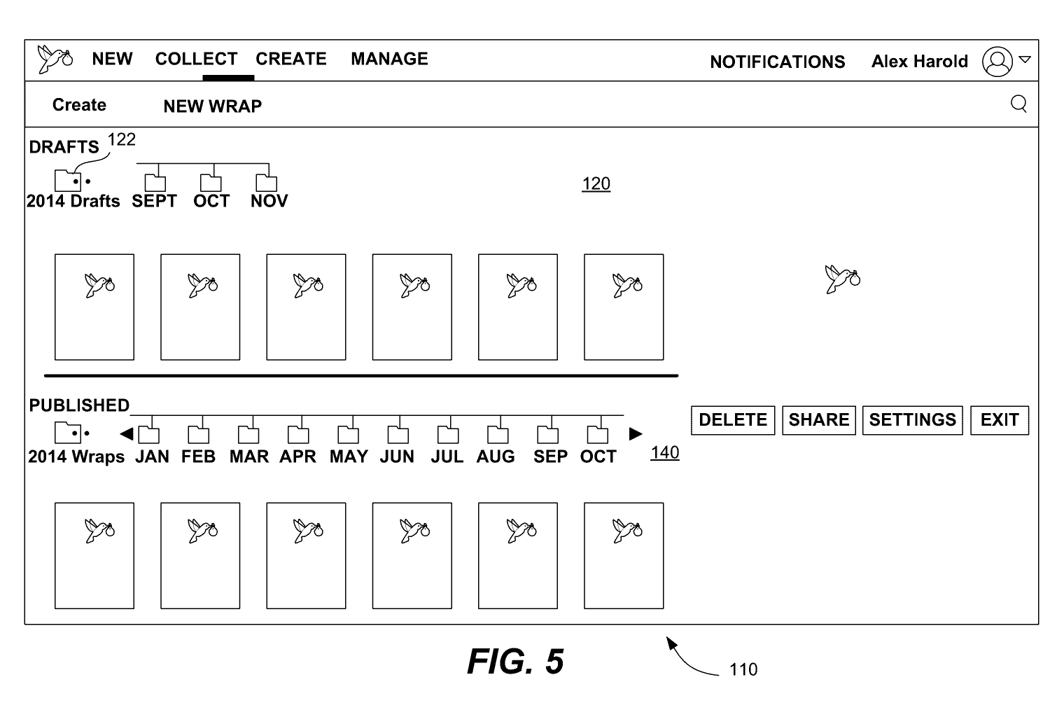

FIG. 5 is a screen shot of a computing device on which a creator is creating a wrap package and makes use of the present invention. In this example, an individual is using the authoring tool 34 in order to create a card or a wrap package of cards and uses the present invention in order to store, manage or perhaps delete cards or wrap packages. Screen 110 appears during the course of this use and displays a first region 120 in which is shown the folder icon 122 labeled “2014 Drafts” as well as a second region 140 including other icons. Folder 122 includes other folders and wrap packages that may be accessed and displayed according to various embodiments of the invention. Although a wide variety of digital items may be stored and accessed using the present invention, including wrap packages, the digital items stored in this example will be referred to simply as computer files.

As mentioned earlier, one advantage of the present invention is the ability to access stored files and folders, and to view that information, using a single mouse click or a simple touch on a screen. And, a wide variety of inputs may be used by a user to effect this control. As mentioned, a user may be using a so-called “click-enabled” device such as a desktop computer in which the user uses a wired or wireless computer mouse (or similar) in order to make selections by clicking. Or, the user may make selections by clicking on a track pad built into a laptop computer (for example), or upon a separate, wireless track pad. For those computing devices (such as mobile telephones and tablet computers) which have touch-sensitive screens, a user makes selections by touching or tapping on the screen itself. And, often a keyboard may be used to navigate on the screen of a computer and make selections by pushing a particular key. For ease of explanation, in this example we refer to “tapping” on an icon, although these other techniques may also be used.

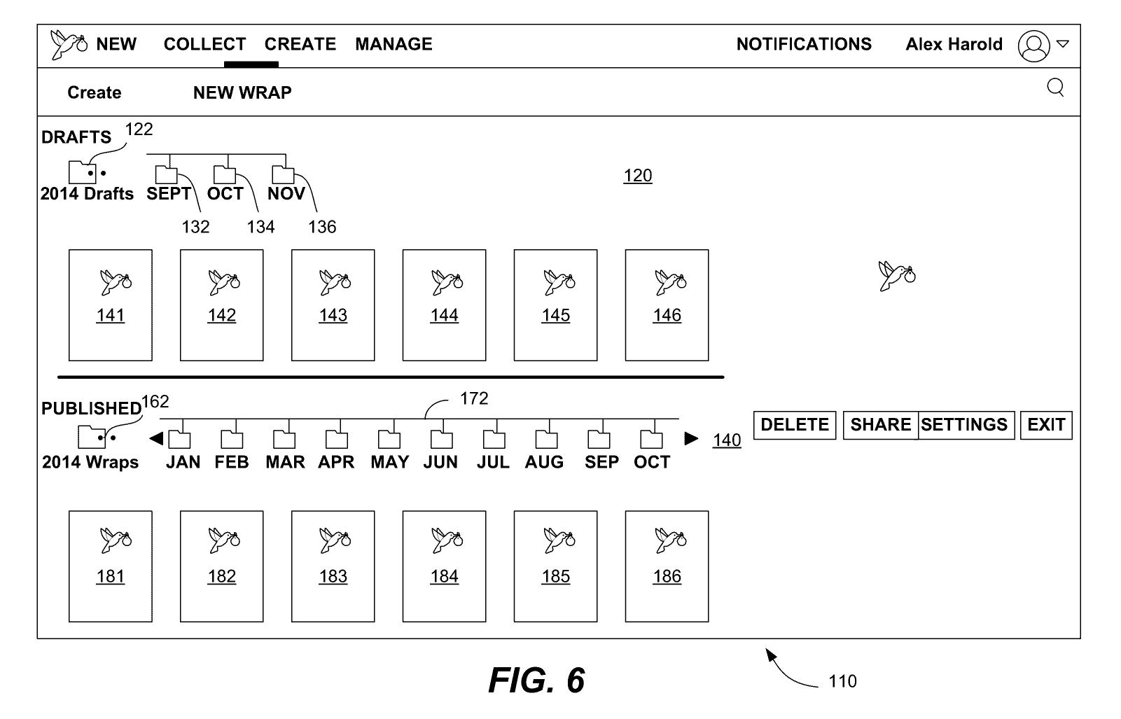

As shown in region 120, folder icon 122 appears and in this example is the root of the storage hierarchy. At this point in time, the user has not yet tapped upon folder 122. Once the user taps once upon folder 122 screen 110 transforms and then appears as shown in FIG. 6.

FIG. 6 is a screen shot of a computing device that appears after the user has tapped upon the folder icon 122. Immediately to the right of folder 122 are all of the child folders 132-136 (sibling folders) that are contained within folder 122 (the parent folder). Below these folders are shown six files 141-146 also contained within folder 122 but not within any of the sibling folders. Thus, with a single tap upon the parent folder (in this example) all of the children folders and files contained within the parent folder are displayed in an intuitive fashion that allows the user to grasp immediately which folders and files belong where. In this example, child folders are displayed in a linear fashion to the right of the parent folder, while computer files contained within the parent folder are displayed in a linear fashion below the parent folder. Of course, these folders and files may be displayed in different locations and need not be displayed in a linear fashion. By grouping these sibling folders and computer files together, and by giving them similar icons, the user can grasp which are which.

Although not shown in this figure, with a single tap upon any one of the sibling folders all of its contents will also be displayed. And, with a single tap upon any one of the files 141-146 the file will be opened (or executed, displayed, etc., depending upon the type of file). Also, a single tap upon any folder that has been opened (such as the parent folder 122) reverses the process and take the user up a level in the storage hierarchy. For example, if a user were to tap upon folder 122 as shown in FIG. 6, then screen 110 would transform and again appear as shown in FIG. 5.

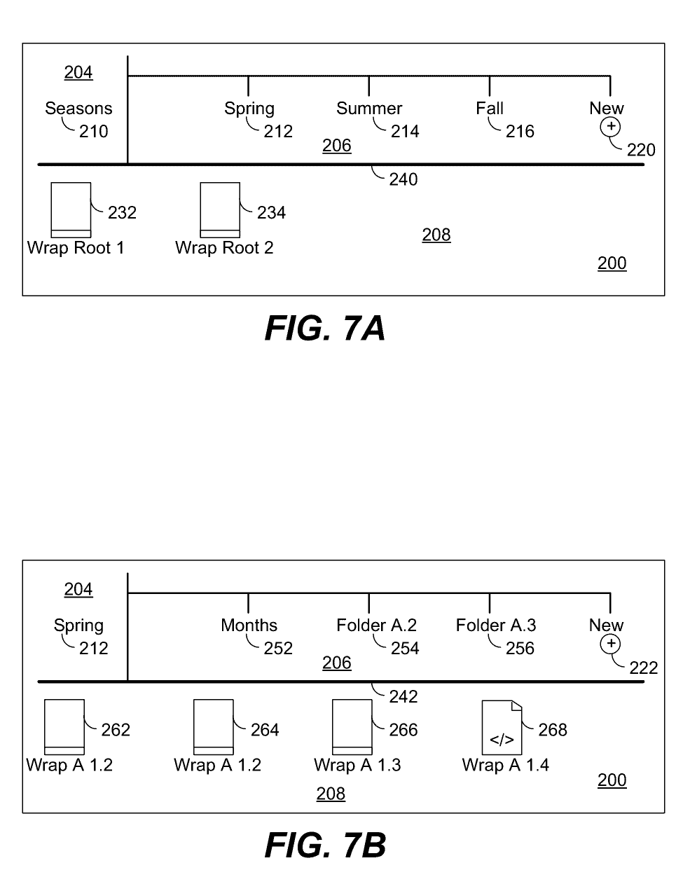

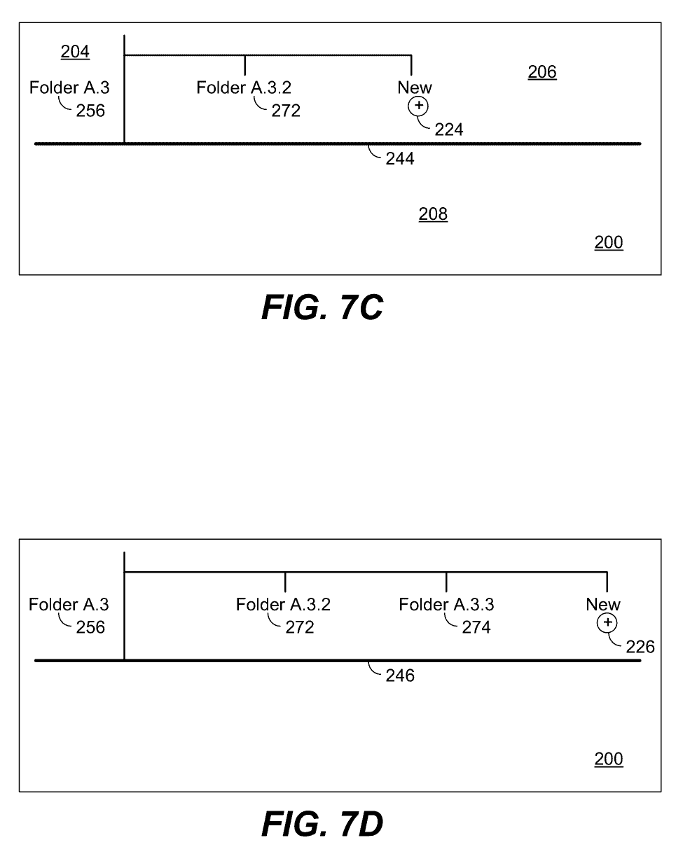

FIGS. 7A-7D illustrate another example of the present invention. In this example, the novel user interface is shown implemented upon a touchscreen 200 of a mobile telephone, such as telephone 12D of FIG. 4.

FIG. 7A shows a parent folder 210 that includes three child or sibling folders 212-216. Included within the parent folder are two wrap packages 232 and 234. In one embodiment, included within every folder as a child folder is an icon “New” 220 that provides functionality to allow the user to create a new child folder with a single tap. In this example, the parent folder is also the root folder and thus tapping upon it collapses all folders and files such that only folder 210 is visible.

This figure shows that parent and child folders are identified by their names and not necessarily by a particular symbol such as is used in the example of FIG. 6. Of course, any symbol, image or text may be used to identify a parent or child folder in various embodiments. As shown, the wrap packages 232 and 234 are identified both by images and by text. Also, note that this example uses a simple graphical element 240 to delineate regions that hold the parent folder, the child folders and any files contained within the parent. By convention, region 204 holds the parent or current folder, region 206 displays the child folders of the current folder, in region 208 displays the files contained within the parent folder. Of course, other conventions may be used.

Also, any such graphical element 240 may be used or may be absent. In one embodiment, no graphical element is used and by convention the current folder appears roughly in the top left of the screen while all of its child folders appear to its right, and any files in the current folder appear below all of the rest. In another embodiment, the parent or current folder uses a unique symbol that is different from a symbol used for all of its child folders, and, each file of the current folder uses yet another unique symbol such that each of the three items may be differentiated simply by their symbols and not necessarily by graphical elements or by placement on the screen.

FIG. 7B shows how the screen transforms after the user taps once upon the “Spring” child folder 212. The user desires to open the “Spring” child folder and to view its contents and thus taps once upon icon 212 in FIG. 7A. The screen transforms and appears as shown in FIG. 7B. The top left position is now occupied by the icon “Spring” which has been figuratively stacked upon its parent folder “Seasons” and the region to the right is now occupied by all of the child folders 252-256 of the parent folder “Spring.” The lower region is now occupied by symbols for wrap packages 262-268 which are present within the “Spring” folder. Also present is the symbol “New” 222 indicating the ability to add a new child folder under the parent folder “Spring” with a single tap.

FIG. 7C shows how the screen appears after the user taps once upon the “Folder A3” child folder 256. The user desires to open the “Folder A3” child folder and to view its contents and thus taps once upon icon 256 in FIG. 7B. The screen transforms and appears as shown in FIG. 7C. The top left position is now occupied by the icon “Folder A3” which has been figuratively stacked upon its parent folder “Spring” and the region to the right is now occupied by the child folder 272 of the parent folder “Folder A3.” The lower region is empty as there are no files contained within the “Folder A3” folder, only a single child folder. Also present is the symbol “New” 224 indicating the ability to add a new child folder under the parent folder “Folder A3.”

FIG. 7D shows how the screen transforms after the user taps once upon the “New” icon 224. The user desires to open a new child folder of the parent folder “Folder A3” 256 and thus taps once upon icon 224 in FIG. 7C. Although not shown, the icon “New” changes to a blank region allowing the user to enter the name of the new folder using the keys on a keyboard, a touchscreen of a mobile device, etc., using techniques known to those of skill in the art. Once the new name “Folder A33” has been entered and the “Return” key pressed (or other similar input), then the screen appears as shown in FIG. 7D, i.e., the new folder 274 appears and another “New” icon 226 now also appears providing the user the opportunity to add yet another new folder.

In addition to opening child folders and new folders, the user may wish to go up a level after opening any number of child folders and to view the contents of folders further up the hierarchy, even up to the root folder. For example, when presented with the screen as shown in FIG. 7C the user may simply tap the current parent folder “Folder A3” 256 once in order to go up one level. In other words, once icon 256 is tapped once, then the screen transforms and will appear as shown in FIG. 7B. Similarly, if icon 212 is tapped once on the screen as shown in FIG. 7B, then the screen transforms and will appear as shown in FIG. 7A. Advantageously, only a single tap is needed not only to go up a level but also to display the contents of the parent folder of the folder that is tapped.

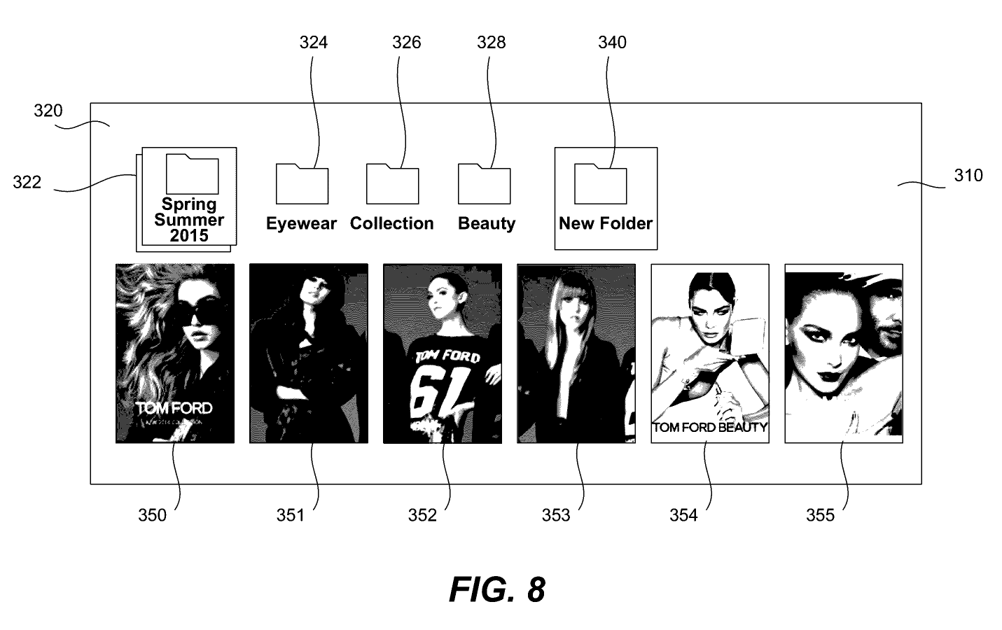

FIG. 8 illustrates yet another example of how the present invention may appear on the screen of a computing device. In this example, screen 310 simply displays the icons for folders and files and does not display any type of graphical element used to delineate regions upon the screen. Shown is a parent folder 320, its child folders 324-328, the files 350-355 contained within the parent folder, and an icon 340 used to create a new folder. In this example, the files are wrap packages.

Note that the child folders use a symbol that is different from the parent folder, and that the files 350-355 are identified by using images, rather than by name. In this fashion, the parent folder, child folders, new folder and files can all be differentiated by their representation, rather than by name or by other graphical elements.

Note that folder 320 is shown being stacked on top of its parent folder 322, unlike the examples in FIGS. 5-7 in which the stacking was inherent but not shown visually. Showing of the stacking in this way of FIG. 8 is optional. Of course, other graphical techniques for showing stacking may also be used.

One advantage of the present invention is its simplicity. Note that while only a single tap is needed to perform certain actions such as open a folder, go up a level, open a file, and open a new folder, other actions are not possible, in order to reduce complexity. For example, the novel interface does not present a way to tap upon folder or files not shown on the screen. Even though the edge of folder 322 can be seen, in order to keep the interface simple and consistent across all devices, one is not able to tap upon folder 322 in order to open it; one must tap upon folder 320 first in order to open it and to go up a level.

### Nested Folder Flow Diagrams

As explained above and as shown in the earlier figures, the present invention provides innovative techniques for displaying containers and files in the hierarchy, for opening and displaying containers, for going up a level in the hierarchy, etc. The techniques may be up implemented upon any of the computing devices shown in FIG. 4, including any computer used by an author within system 34 while creating a wrap package of cards. And, in other embodiments the techniques of the present invention may be implemented upon computing devices and in systems that display and manage computer files other than cards and wrap packages of cards. In fact, the present invention is applicable to any similar file folder metaphor in which there are parent-child relationships.

In the embodiment in which the present invention is used with wrap packages of cards, the techniques may be implemented within the wrap runtime viewer. The wrap viewer may be present upon a computer server used to create a wrap packages of cards (such as a computer within authoring system 34), may be delivered over a wired or wireless network connection to one of the computing devices shown in FIG. 4 along with a wrap package of cards, or may exist within a native application on one of those computing devices.

Because it is contemplated that wrap packages of cards may be created and rendered on a wide variety of computing devices, the techniques of the present invention may be implemented using a wide variety of software code in order to interact with the operating system and persistent storage of the underlying computing device. For example, the present invention may be implemented using XML nodes, JSON (JavaScript Object Notation), native constructs from database queries, or an API of a particular operating system.

In addition, although the description herein refers often to a computer “folder,” and although images of folders that include child folders and other digital objects are shown in FIGS. 5, 6 and 8, the present invention is not limited to such images. The term “folder” is a convenient name for a logical container that contains other folders (or logical containers) or digital objects such as computer files, images, wrap packages, etc. In fact, the embodiment shown in FIG. 7A-7D illustrates use of the invention using simply a symbolic name for the logical container, rather than an image of a folder or other. As used herein, the term “folder” or “container” indicates a logical construct that contains other folders or containers or digital objects. Such container may be indicated on a screen of a computing device using an image of a folder, a symbolic name, or any other suitable symbol.

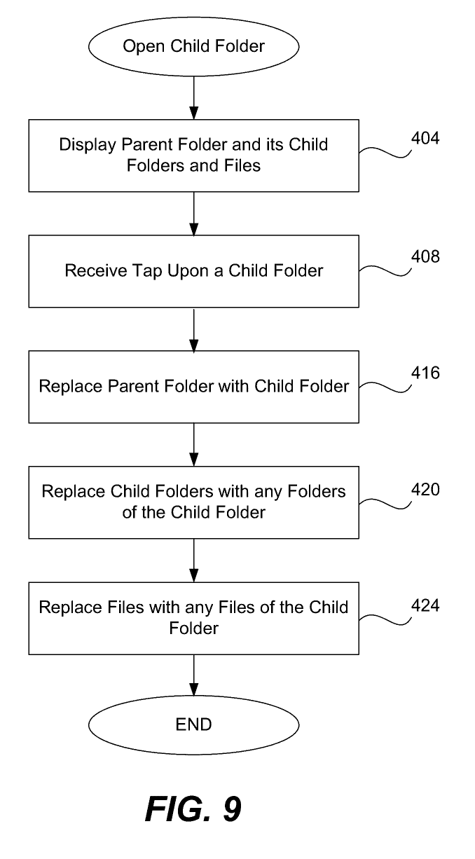

FIG. 9 is a flow diagram describing one embodiment in which a child folder is opened and displayed. Consider a mobile telephone on which are stored any number of wrap packages in persistent storage of the telephone. In a first step 404, the wrap viewer displays folders and wrap packages on a screen 200 of the telephone as shown in FIG. 7A. Folder 210 is the parent folder (and in this example, it is also the root folder) and folders 212-216 are its child folders. There may be fewer child folders in region 206 and a greater or fewer number of wrap packages in region 208. The user of the device desires to view the contents of the child folder “Spring” 212 and thus taps upon the icon “Spring” on the screen 200 of the device in step 408. Of course, depending upon the device, the user may select this icon in other ways such as by using a wired or wireless computer mouse, by using a computer keyboard, by using a stylus, etc.

Once tapped, the screen transforms as is described below. In step 416 parent folder 210 is replaced with the child folder 212 and region 204 now appears as shown in FIG. 7B. In step 420 child folders 212-216 are replaced with any child folders of the folder “Spring” and region 206 now appears as shown in FIG. 7B in which the child folders 252-256 of the folder “Spring” now appear. As mentioned above, a “New” icon 222 preferably appears as an option in the list of child folders.

In step 424 wrap packages 232 and 234 are replaced with wrap packages 262-268 which are the wrap packages contained within the folder “Spring”, and region 208 now appears as shown in FIG. 7B. Accordingly, by tapping only once upon the icon “Spring” its child folders and any wrap packages contained within it are displayed on the screen and the previous display of child folders and wrap packages contained within the parent folder “Seasons” can no longer be seen.

Tapping once upon the folder in order to display its contents also works upon any parent folder which is not yet been opened. For example, tapping once upon parent folder 122 of FIG. 5 results in the display of its child folders 132-136 and any computer files 141-146 contained within it as shown in FIG. 6.

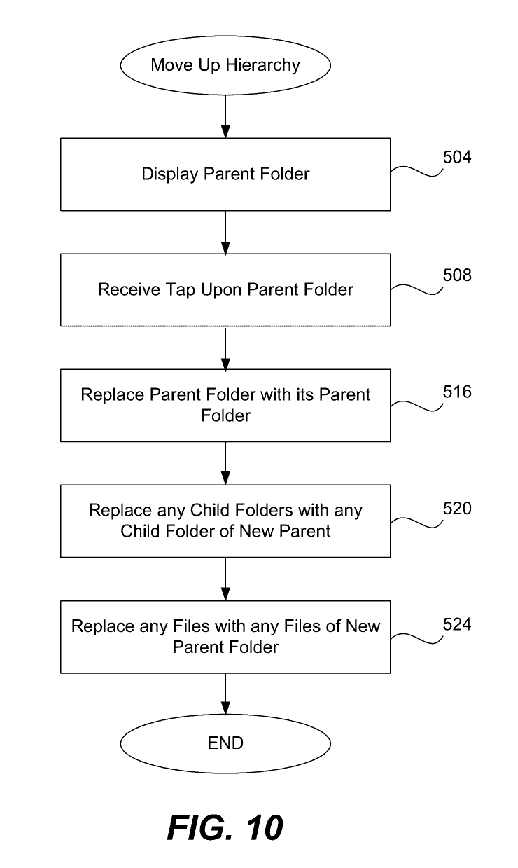

FIG. 10 is a flow diagram describing one embodiment in which a user moves up one level in a hierarchy. Consider a mobile telephone on which are stored any number of wrap packages in persistent storage of the telephone. In a first step 504, the wrap viewer displays a parent folder 256 and any child folders and any wrap packages that the parent folder contains on a screen 200 of the telephone as shown in FIG. 7C. It is possible the folder 256 has no child folders or files, and thus regions 206 and 208 will be empty.

The user of the device desires to close folder 256 and to move up one level in the hierarchy and thus taps upon the icon “Folder A3” on the screen 200 of the device in step 508. Of course, depending upon the device, the user may select this icon in other ways such as by using a wired or wireless computer mouse, by using a computer keyboard, by using a stylus, etc.

Once tapped, the screen transforms as is described below. In step 516 folder 256 is replaced with its parent folder 212 and region 204 now appears as shown in FIG. 7B. In step 520 child folder 272 is replaced with any child folders of the new parent folder “Spring” and region 206 now appears as shown in FIG. 7B in which the child folders 252-256 of the folder “Spring” now appear. As mentioned above, a “New” icon 222 preferably appears as an option in the list of child folders.

In step 524 any files in region 208 are replaced with any files contained within the new parent folder, namely, wrap packages 262-268 which are the wrap packages contained within the folder “Spring”, and region 208 now appears as shown in FIG. 7B. Accordingly, by tapping only once upon the icon “Folder A3” not only is the folder closed, but also the display shows the next level up in the hierarchy and opens up the parent of “Folder A3” and displays its contents. The contents of “Folder A3” can no longer be seen.

Tapping once upon a folder in order to move up a level has a different effect if the folder is the root folder. For example, tapping once upon folder 122 of FIG. 6 will close the folder, and the display will appear as shown in FIG. 5, but as this root folder has no parent, there is no display of the contents of its parent. Tapping once upon folder 122 of FIG. 5 as the effect of opening it, as discussed with reference to FIG. 9.

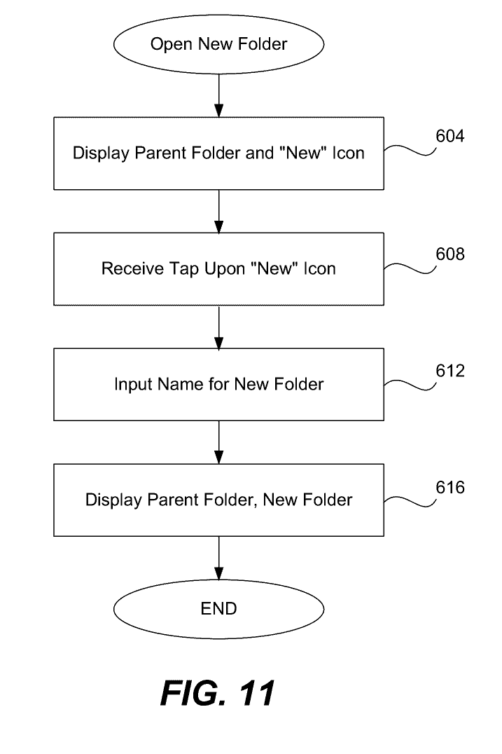

FIG. 11 is a flow diagram describing one embodiment in which a user opens a new folder. In a first step 604, the wrap viewer displays a parent folder 256 and any child folders and any wrap packages that the parent folder contains on a screen 200 of the telephone as shown in FIG. 7C. It is possible the folder 256 has no child folders or files, and thus regions 206 and 208 will be empty, although in a preferred embodiment, “New” icon 224 is always present as a child of the current parent folder.

The user of the device desires to open a new folder and thus taps upon the icon “New” 224 on the screen 200 of the device in step 608. Of course, depending upon the device, the user may select this icon in other ways such as by using a wired or wireless computer mouse, by using a computer keyboard, by using a stylus, etc.

Once tapped, the screen transforms as is described below. In step 612 the user is prompted to input a name (not shown) for the new folder and such input may be accomplished by ways known to those of skill in the art. For example, the icon “New” may be replaced by a blank space and a blinking cursor as is known in the art and the user is allowed to enter a new name such as by using a keyboard of the computing device. Or, if using a smart phone, the lower half the screen may transform into a virtual keyboard and the user enters a new name by tapping on the virtual keys or by speaking the new name into a microphone of the device. Instead of requiring the user to actually enter a new name, the technique may automatically assign a default name to the new folder based upon the context, such as by an existing name of a sibling folder, the name of the parent folder, the date, etc. For example, as shown in FIG. 7C, a default name for the new folder may simply be the name of the sibling folder incremented by one (e.g., “Folder A.3.3”). In this fashion, the user is not required to enter any information in order to name the new folder and creation and naming of the new folder all happen with only a single tap on the screen of the device (or a single click of the mouse).

Once a name has been created for the new folder using any of the above techniques in step 616 the wrap viewer then displays the new hierarchy as shown in FIG. 7D. This figure shows the new folder 274 which has been named automatically and also another “New” icon 226 which preferably is always present as a child folder of any parent folder so that a user may yet add yet another folder.

Thus, with only a single tap on the screen a new folder is created in the folder hierarchy.

In addition to the above techniques of opening a folder, moving up a level or creating a new folder, a single tap on a file or wrap package is all that is needed to initiate an action for that file or wrap package. For example, FIG. 8 shows wrap packages 350-355, tapping once on one of these wrap packages immediately executes the wrap package and renders it on the computing device allowing the user to swipe through the cards of the wrap package, such as the cards shown in FIG. 1.

As mentioned above, contained within any parent or child folder may also be other types of digital objects such as computer files, images, videos, etc., and a single tap also serves, depending upon the type of digital object, to open a file, to execute an executable file, to print a document, to save the file, to copy or to paste, the play a video or sound file, etc.

### Benefits and Advantages of Wrap Packages

Wrap packages 10 offer a number of benefits and attributes currently not available with conventional methods of distributing content, such as with PDFs, web sites, or stand-alone apps. Since cards 14 can be sequenced and authored to include media content, application functionality, and e-commerce related services, wrap packages 10 have the unique ability to narrate a story, in a book-like format, that captures and holds the attention of the viewer, while also offering an “app” like user experience. As such, wrap packages 10 offer a new web-based platform for storytelling, communicating ideas, and delivering highly visual and functional user experiences. Wrap packages 10 thus enable a new business paradigm for selling, advertising, publishing, increasing brand loyalty, offering services, and contacting and engaging new and old customers alike, all ideally delivered to consumers on their mobile devices, where they spend their time and consciousness. Where businesses used to have to build destinations (e.g., websites) or monolithic systems (e.g., “apps”), they can now, instead, provide consumers with wrap packages 10, that are delivered like messages, and that provide the user experiences and functionality they really want and need. As a result, wraps 10 create opportunities for business to innovate and improve products and services, leveraging the mobile web in ways not before possible, because a convenient, enabling interface and platform did not previously exist.

Wrap packages 10 are also like interactive messages that can be easily shared, delivered over the mobile web, and locally stored. With the ability to share, distribute over the mobile web and locally store, popular wrap packages can readily go viral.

Wrap packages 10 are also preferably delivered using a SaaS (Software as a Service) model, meaning wrap packages are delivered only on an as-needed basis.

Wrap packages can be authored by anyone, from an individual with little technical or design skills, to large and sophisticated enterprises.

Wrap packages 10 can be distributed narrowly to a specific or targeted person or persons or widely distributed to many, many persons.

Wrap packages 10 can be written once and can run on just about any browser enabled device. As a result, wraps are not platform, operating system, or device dependent.

Since wrap packages 10 can be easily generated and optionally dynamically updated with new content, wrap packages can be used as a digital “corollary” or “companion”, accompanying the sale or rental of goods and/or services. For example, wrap packages can be created and distributed as an “Active Receipt” accompanying the sale or rental of a good or service. The merchant can thus provide through the wrap package 10 ongoing contact and support to on-board, up-sell and/or cross-sell the customer with ancillary goods and/or services, potentially for the entire life cycle of the product or service, all delivered in a digital format that never gets lost or misplaced. Accordingly, wrap packages can be used as an essential component of any product or service, delivering better customer service and creating new selling opportunities.

In summary, wrap packages 10 introduce the “narrative web”, which is a storytelling mobile user interface, delivered over a cloud-based platform, ushering in a digital evolution of mobile marketing and customer relationship management. As a marketing tool, wrap packages 10 have the unique ability to increase mobile engagement, lead generation, and conversion, enabling businesses to increase sales, improve loyalty, and enhance customer relationships and loyalty. Wrap packages 10 thus offer a compelling business proposition by solving one of the biggest problems in the mobile space of today; namely the lack of connectivity between apps. With wrap packages 10, however, consumers and other users can enjoy a multi-function app-like experience, without having to be in an app, download an app, or open any apps.

Finally, while many of the benefits and attributes of wrap packages 10 are realized on mobile devices operating on the mobile web, it should be made clear that there is nothing inherent with wrap packages 10 that limit their usefulness or functionality in non-mobile environments. On the contrary, wrap packages 10 can also be used, and all the same benefits and attributes realized, on non-mobile devices, such as desktop computers and/or smart TVs for example.

The present invention is thus intended to be broadly construed to cover any system and method, such as carousel ads for example, that enables publishers and marketers to tell sequenced stories with (i) a combination of images, photos, text, video and other types of media, (ii) a swipe-able format that enables viewers to navigate the media displayed in one screen shot or frame to the next, and (iii) includes embedded app-like functionality and/or links to other locations that provide additional information or such functionality and/or services. Consequently, the present application should not be construed to just those specific embodiments as described herein.

In the primary described embodiments, all of the behaviors are declared rather than being stored in-line within the descriptor. Thus, the descriptor itself does not have any programmable logic. In many embodiments, the declared behavior are all defined within the runtime viewer such that the runtime view can readily associate the desired behavior with the wrap, card or component as appropriate in a runtime instance of the wrap. It should be appreciated that this is a particularly powerful framework for enhancing portability of the wraps. With the descriptor/runtime viewer approach, a single item (the descriptor) can be used to define all of the content and functionality of a set of cards that can be rendered on virtually any platform. The declared functionality is provided (or obtained) by the runtime viewers when the wrap is to be rendered so that the author of the wrap is not required to know or understand any of the idiosyncrasies of any particular platform. The runtime viewer may be a generic runtime viewer (e.g., a viewer executable by a conventional browser) or may be native viewer customized for a particular platform. Regardless of the underlying platform, the runtime viewer handles the tasks of associating the declared behaviors with the wrap/cards/components which frees the wrap author and/or authoring tool from having to ensure that desired behaviors are programmed correctly for all of the different platforms that the wrap may be rendered on.

In most implementations, all of the sizeable assets that serve as content of the wrap are referenced in the wrap by appropriate identifiers rather than being stored directly in the wrap. This again significantly enhances portability by keeping the size of the descriptor small while facilitating the use of rich media content.

From the foregoing it should be apparent that the described wrap packages provide businesses with a powerful tool for engaging their customers, suppliers, employees or other constituents in a format that is particularly well tailored for display on mobile devices.

Although only a few embodiments of the invention have been described in detail, it should be appreciated that the invention may be implemented in many other forms without departing from the spirit or scope of the invention. For example several specific wrap descriptor structures have been described. Although such descriptor structures work well, it should be appreciated that the actual descriptor structure may vary widely. For example, in some embodiments some special behaviors can be defined within a wrap descriptor if desired. Such in-line behavior definition might be particularly useful in association with certain behavior extensions that are not otherwise readily available. For example, JavaScript can be included within a JSON object and various other descriptor structures. Thus, when JSON descriptors are used, selected behaviors or behavior overrides can be defined in-line using JavaScript if desired. Although programmed functionality can be included in some circumstances, it should be appreciated that liberal definition of behaviors within a wrap tends to defeat some of the primary advantages of the described descriptor/runtime viewer framework.

In many implementations much of the actual content of the wrap will be referenced by the descriptor rather than being stored in-line within the descriptor. However, the balance between in-line storage and references to external assets in any particular wrap descriptor may be widely varied anywhere from 100% referenced content to (at least theoretically) 100% in-line content—although the later is less desirable for media rich content and again, begins to defeat some of the advantages of using the descriptor approach. The choice between in-line and referenced content will typically be dictated in large part by the relative size of the content. For example, text, which tends to be very compact, is generally more suitable for inclusion in-line, whereas more graphic media, images, videos and/or audio files are typically more efficiently referenced.

A few different methods of and architectures for serving wrap packages and constructing runtime instances have been described herein. Although only a few approaches have been described in detail, it should be apparent from the foregoing that a wide variety other methods and architectures can be used as well. Therefore, the present embodiments should be considered illustrative and not restrictive and the invention is not to be limited to the details given herein, but may be modified within the scope and equivalents of the appended claims.

We claim:

1. A computer-readable medium comprising computer code for accessing a digital object, said computer code of said computer-readable medium executable by a machine to perform the following:
displaying a parent container icon in a first region on a screen of a computing device and a child container icon in a second region on said screen, said child container icon being logically contained within said parent container icon;
receiving a single user action on said computing device indicating said child container icon by a user of said computing device;
replacing said parent container icon in said first region with said child container icon;
displaying exclusively in said second region at least one sub-child container icon, said sub-child container icon being logically contained within said child container icon; and
displaying exclusively in a third region on said screen said digital object, said digital object being logically contained within said child container icon.

2. A medium as recited in claim 1, wherein said digital object is a wrap package of cards, said medium further comprising computer code to perform:
receiving a single user action on said computing device indicating said wrap package of cards; and
rendering said wrap package of cards on said screen of said computing device.

3. A medium as recited in claim 1, wherein said single user action is a tap upon said child container icon, a click upon said child container icon, or a keyboard entry indicating said child container icon.

4. A medium as recited in claim 1, said medium further comprising computer code to perform:
before said receiving, displaying at least a second digital object in said third region, said second digital object being logically contained within said parent container icon.

5. A medium as recited in claim 1, wherein after said receiving said parent container icon cannot be accessed with a single user action.

6. A medium as recited in claim 1, said medium further comprising computer code to perform:
before said receiving, displaying a plurality of container icons in said second region, each of said container icons being logically contained within said parent container icon.

7. A medium as recited in claim 1, said medium further comprising computer code to perform:
receiving a single user action on said computing device indicating said digital object; and
executing an action upon said digital object that depends upon a type of said digital object.

8. A computer-readable medium comprising computer code for accessing a digital object, said computer code of said computer-readable medium executable by a machine to perform the following:
displaying a child container icon in a first region on a screen of a computing device and a sub-child container icon in a second region on said screen, said sub-child container icon being logically contained within said child container icon;
receiving a single user action on said computing device indicating said child container icon by a user of said computing device;
replacing said child container icon in said first region with a parent container icon, said child container icon being logically contained within said parent container icon;
displaying in said second region at least said child container icon, wherein said second region exclusively contains only any container icons that are logically contained within said parent icon; and
displaying exclusively in a third region on said screen said digital object, said digital object being logically contained within said parent container icon.

9. A medium as recited in claim 8, wherein said digital object is a wrap package of cards, said medium further comprising computer code to perform:
receiving a single user action on said computing device indicating said wrap package of cards; and
rendering said wrap package of cards on said screen of said computing device.

10. A medium as recited in claim 8, wherein said single user action is a tap upon said child container icon, a click upon said child container icon, or a keyboard entry indicating said child container icon.

11. A medium as recited in claim 8, said medium further comprising computer code to perform:
before said receiving, displaying at least a second digital object in said third region, said second digital object being logically contained within said child container icon.

12. A medium as recited in claim 8, wherein after said receiving said sub-child container icon cannot be accessed with a single user action.

13. A medium as recited in claim 8, said medium further comprising computer code to perform:
receiving a single user action on said computing device indicating said digital object; and
executing an action upon said digital object that depends upon a type of said digital object.

14. A computer-readable medium comprising computer code for creating a new container icon, said computer code of said computer-readable medium executable by a machine to perform the following:
displaying a parent container icon in a first region on a screen of a computing device and a first child container icon in a second region on said screen, said first child container icon being logically contained within said parent container icon;
displaying in said second region a create icon;
receiving a single user action on said computing device indicating said create icon by a user of said computing device;
in response to said receiving, displaying in said second region a second child container icon, said second child container icon being logically contained within said parent container icon; and
continuing to display said create icon.

15. A medium as recited in claim 14, said medium further comprising computer code to perform:
storing a digital object within persistent storage of said computing device; and
logically placing said digital object within said second child container icon.

16. A medium as recited in claim 14, wherein said single user action is a tap upon said child container icon, a click upon said child container icon, or a keyboard entry indicating said child container icon.

17. A medium as recited in claim 14, said medium further comprising computer code to perform:
providing a default name to said second child container icon not requiring any input by said user; and
displaying said default name as a representation of said second child container icon on said screen.

18. A computer-readable medium comprising computer code for accessing a digital object, said computer code of said computer-readable medium executable by a machine to perform the following:
displaying a parent container icon on a screen of a computing device;
displaying on said screen at least one child container icon and a first digital object that are both logically contained within said parent container icon;
receiving a single user action on said computing device indicating said child container icon by a user of said computing device;
in response to said receiving, removing said parent container icon and said digital object from said screen;
in response to said receiving, displaying on said screen at least one sub-child container icon and a second digital object that are both logically contained within said child container icon, wherein said screen only displays container icons and digital objects that are logically contained within said child container icon.
